(19) United States
(12) Patent Application Publication
(10) Pub. No.: US 2024/0112857 A1
(43) Pub. Date: Apr. 4, 2024

(54) METHOD OF PREPARING ANISOTROPIC MAGNETIC POWDER COMPRESSION MOLDED PRODUCT AND BONDED MAGNET

(71) Applicant: NICHIA CORPORATION, Anan-shi (JP)

(72) Inventors: Takashi ASADA, Anan-shi (JP); Shuichi TADA, Komatsushima-shi (JP)

(73) Assignee: NICHIA CORPORATION, Anan-shi (JP)

(21) Appl. No.: 18/478,965

(22) Filed: Sep. 29, 2023

(30) Foreign Application Priority Data
Sep. 30, 2022 (JP) 2022-158605
Mar. 8, 2023 (JP) 2023-035586
Sep. 22, 2023 (JP) 2023-158462

(51) Int. Cl. H01F 41/02; B22F 1/05; B22F 1/142; B22F 1/145; B22F 3/02; B22F 3/26; H01F 1/059

(52) U.S. Cl. CPC H01F 41/0266; B22F 1/05; B22F 1/142; B22F 1/145; B22F 3/02; B22F 3/26; H01F 1/059; B22F 2003/248; B22F 2301/355; B22F 2998/10

(57) ABSTRACT

A method of preparing an anisotropic magnetic powder compression molded product, the method including: compressing a magnetic powder in a mold using a compression punch while magnetically orienting the magnetic powder to obtain a compressed magnetic powder, wherein the compression punch has a contact surface with the magnetic powder that is not perpendicular to a compression direction; and compression molding the compressed magnetic powder using a molding punch having a different shape from the compression punch.

### CROSS-REFERENCE TO RELATED PATENT APPLICATION

This application claims priority to Japanese Patent Application No. 2022-158605 filed on Sep. 30, 2022, Japanese Patent Application No. 2023-035586 filed on Mar. 8, 2023, and Japanese Patent Application No. 2023-158462 filed on Sep. 22, 2023. The disclosures of Japanese Patent Application No. 2022-158605, Japanese Patent Application No. 2023-035586, and Japanese Patent Application No. 2023-158462 are hereby incorporated by reference in their entirety.

### BACKGROUND

The present disclosure relates to a method of preparing an anisotropic magnetic powder compression molded product and a bonded magnet.

JP 2014-146655 A discloses a bonded magnet containing a rare earth magnetic powder and a binder including a thermoplastic resin and a thermosetting resin. According to its teachings, a bonded magnet having a high magnetic powder filling factor without a decrease in strength may be produced by preparing a molded product in which a magnetic powder is bonded with a small amount of thermoplastic resin enough to retain the shape, and then impregnating the voids in the molded product with a liquid thermosetting resin to reduce the resin component content compared to conventional bonded magnets. Moreover, JP 2019-173102 A discloses a manufacturing method that includes compressing a magnetic powder with a punch, pulling back the punch, and then applying pressure with the punch or another punch.

However, JP 2014-146655 A does not disclose the structure of a punch, and JP 2019-173102 A discloses only the punch or another punch whose entire contact surface with the magnetic powder has a flat surface perpendicular to the compression direction. These methods cannot be expected to greatly improve the magnetic powder filling factor and magnetic orientation ratio.

### SUMMARY

A method of preparing an anisotropic magnetic powder compression molded product according to an embodiment(s) of the present disclosure aims to provide an anisotropic magnetic powder compression molded product excellent in both magnetic powder filling factor and magnetic orientation ratio. Moreover, a bonded magnet according to an embodiment(s) of the present disclosure aims to provide a bonded magnet having excellent magnetic properties.

A method of preparing an anisotropic magnetic powder compression molded product according to an exemplary embodiment of the present disclosure includes: compressing a magnetic powder in a mold using a compression punch while magnetically orienting the magnetic powder to obtain a compressed magnetic powder, wherein the compression punch has a contact surface with the magnetic powder that is not perpendicular to a compression direction; and compression molding the compressed magnetic powder using a molding punch having a different shape from the compression punch.

A bonded magnet according to an exemplary embodiment of the present disclosure contains a magnetic powder and a cured thermosetting resin, and has a magnetic powder filling factor that is 70 vol % or more and a magnetic orientation ratio that is 96% or more.

The method of preparing an anisotropic magnetic powder compression molded product according to an embodiment of the present disclosure can provide a compression molded product having a high magnetic powder filling factor and a high magnetic orientation ratio, and the compression molded product can be used to provide a bonded magnet with improved magnetic properties.

### BRIEF DESCRIPTION OF DRAWINGS

FIG. 1 is a process flowchart illustrating steps in a method of preparing an anisotropic magnetic powder compression molded product according to an embodiment of the present disclosure.

FIG. 2 is a process flowchart illustrating steps in a method of preparing an anisotropic magnetic powder compression molded product according to another embodiment of the present disclosure.

FIG. 3 is a perspective view of a compression apparatus filled with a magnetic powder used in the compressing step in FIG. 1.

FIG. 4A is a perspective view of a first compression punch used in a preparation method according to an embodiment of the present disclosure.

FIG. 4B is a perspective view of a second compression punch used in the preparation method according to the embodiment of the present disclosure.

FIG. 5A is a perspective view of another first compression punch used in a preparation method according to an embodiment of the present disclosure.

FIG. 5B is a perspective view of another second compression punch used in the preparation method according to the embodiment of the present disclosure.

FIG. 6A is a perspective view of a movable first compression punch used in a preparation method of an embodiment of the present disclosure.

FIG. 6B is a perspective view of a movable second compression punch used in the preparation method of the embodiment of the present disclosure.

FIG. 7 is a perspective view of a flat punch used in a preparation method of an embodiment of the present disclosure.

### DETAILED DESCRIPTION

Embodiments of the present disclosure are described in detail below. The following embodiments, however, are intended as examples to embody the technical idea of the present disclosure and are not intended to limit the scope of the present disclosure to the following embodiments. As used herein, the term “step” encompasses not only an independent step but also a step that may not be clearly distinguished from other steps, as long as a desired object of the step is achieved.

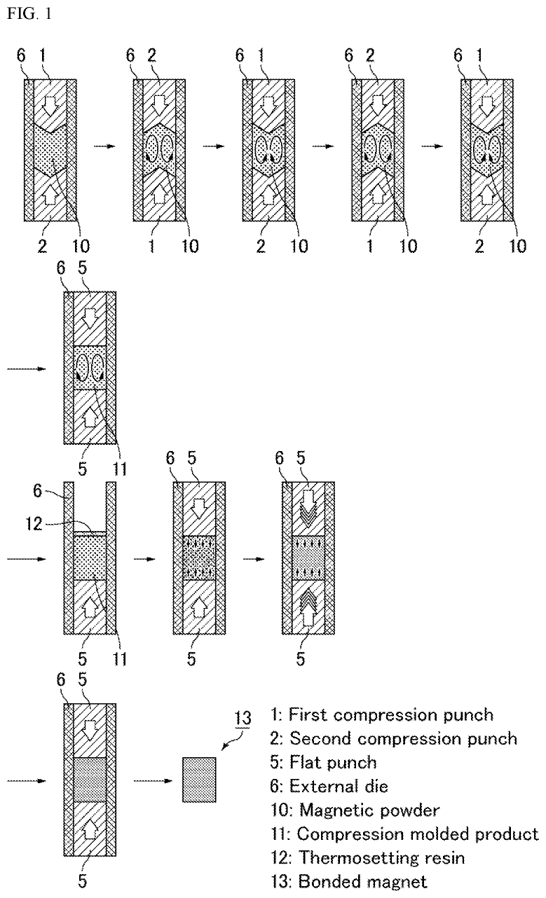

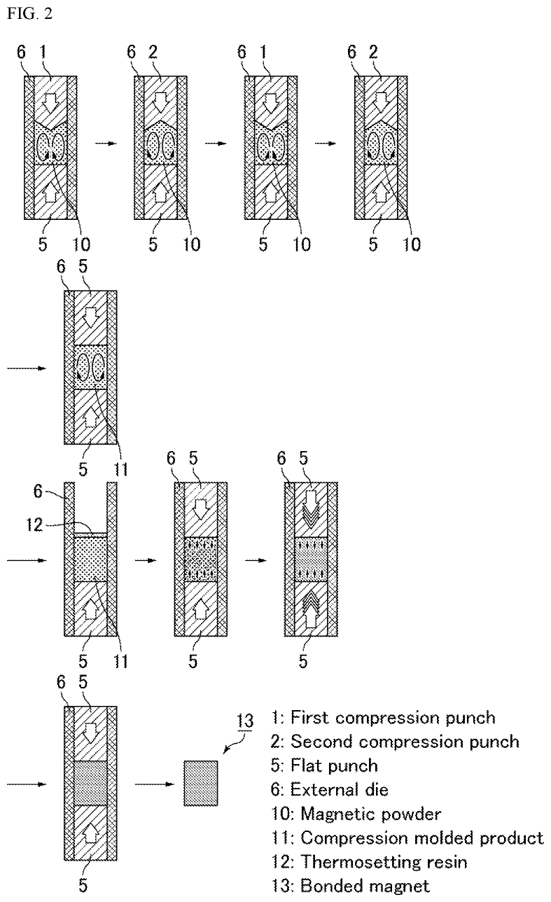

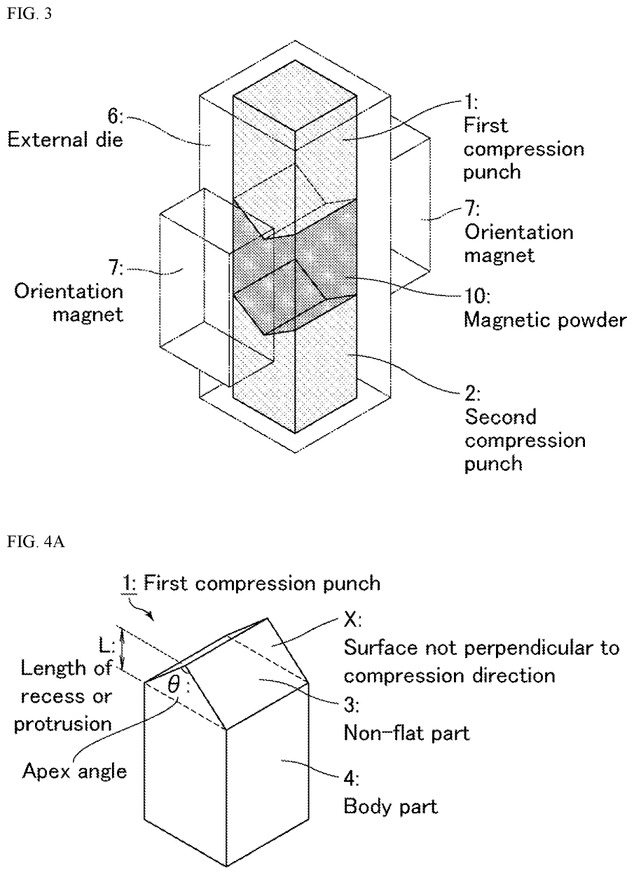

A method of preparing an anisotropic magnetic powder compression molded product according to embodiments of the present disclosure includes: compressing a magnetic powder in a mold using a compression punch while magnetically orienting the magnetic powder, wherein the compression punch has a contact surface with the magnetic powder that is not perpendicular to a compression direction; and compression molding the compressed magnetic powder using a molding punch having a different shape from the compression punch. FIGS. 1 and 2 each show specific examples of steps in the preparation method of the present embodiments. FIGS. 1 and 2 each show a process flowchart including a compressing step (topmost step) and a compression molding step (second step), and optionally a thermosetting resin contacting step (third step) and a heat treatment step (fourth step). FIG. 3 shows a perspective view of an apparatus for preparing an anisotropic magnetic powder compression molded product, including orientation magnets and used in the method of preparing an anisotropic magnetic powder compression molded product of the present embodiments. Here, FIGS. 1 and 2 show views seen from the side of an apparatus equipped with orientation magnets 7 as shown in FIG. 3, and the orientation magnets 7 are installed on the front and back of the paper although they are omitted in the figures.

Compressing step

In the compressing step, a magnetic powder may be compressed in a mold using a compression punch while magnetically orienting the magnetic powder, wherein the compression punch has a contact surface with the magnetic powder that is not perpendicular to the compression direction. The topmost steps shown in FIGS. 1 and 2 correspond to compressing steps. When a flat punch is used whose entire contact surface with the magnetic powder is perpendicular to the compression direction, the pressure applied to the magnetic powder is uniform, and the magnetic powder moves only in the direction perpendicular to the pressure direction. This leads to the problem that the magnetic powder, especially near the center, is less likely to be oriented. When the magnetic powder is compressed in a mold using a compression punch having a contact surface with the magnetic powder that is not perpendicular to the compression direction, the fluidity of the magnetic powder increases during the compression, facilitating orientation of the magnetic powder near the center. As a result, not only the magnetic powder filling factor but also the magnetic orientation ratio are improved.

In the compressing step, the magnitude of the external magnetic field applied for magnetic field orientation is not limited, but is preferably 0.5 T or more, more preferably 1 T or more. An external magnetic field of less than 0.5 T may fail to sufficiently orient the magnetic powder.

The structure of the mold used in the compressing step is not limited, and may be, for example, a mold including an external die, an inner plate placed in the external die, a set of a compression punch and a molding punch for applying pressure to the contents from opposite directions, and a spring for holding the external die. In particular, when a bonded magnet containing a cured thermosetting resin is to be prepared, the mold preferably has an inner plate to facilitate removal of extra thermosetting resin left after contacting with the thermosetting resin. The size of the mold is not limited, but is preferably such that the molded product has a volume of at least 0.1 cm³ but not more than 10 cm³ to facilitate removal of extra thermosetting resin.

The compression punch has a contact surface with the magnetic powder that is not perpendicular to the compression direction. The term “perpendicular” means substantially perpendicular (90°±5°), preferably perfectly perpendicular. Here, the surface not perpendicular to the compression direction does not include any side surface of the compression punch facing closest to the side surface of the cavity in the mold to be filled with the magnetic powder, that is, any surface including the outermost circumference of the compression punch in the direction perpendicular to the compression direction (the side surface of the body part described later). In other words, the contact surface with the magnetic powder does not include any side surface of the compression punch between which and the side surface of the cavity there is a gap large enough to allow the magnetic powder to unintentionally enter. The surface not perpendicular to the compression direction may be flat or partially or fully curved. Although the compression punch is required to have at least a contact surface with the magnetic powder that is not perpendicular to the compression direction, part of the contact surface may be a surface not perpendicular to the compression direction, or the entire contact surface may be a surface not perpendicular to the compression direction.

Specific examples of the compression punch include a first compression punch having a protruding contact surface with a magnetic powder, a second compression punch having a recessed contact surface with a magnetic powder, a punch having an inclined contact surface with a magnetic powder, and a punch having a contact surface with a magnetic powder that has a plurality of protrusions or recesses thereon. The compression punch may also be a movable compression punch which is partially movable to form a protruding or recessed contact surface with the magnetic powder so that it can serve as the first compression punch or second compression punch. Here, the contact surface with the magnetic powder of the movable compression punch is not required to be always a surface not perpendicular to the compression direction during the compression in the compressing step. It is sufficient for the contact surface with the magnetic powder to be a surface not perpendicular to the compression direction during part of the compression.

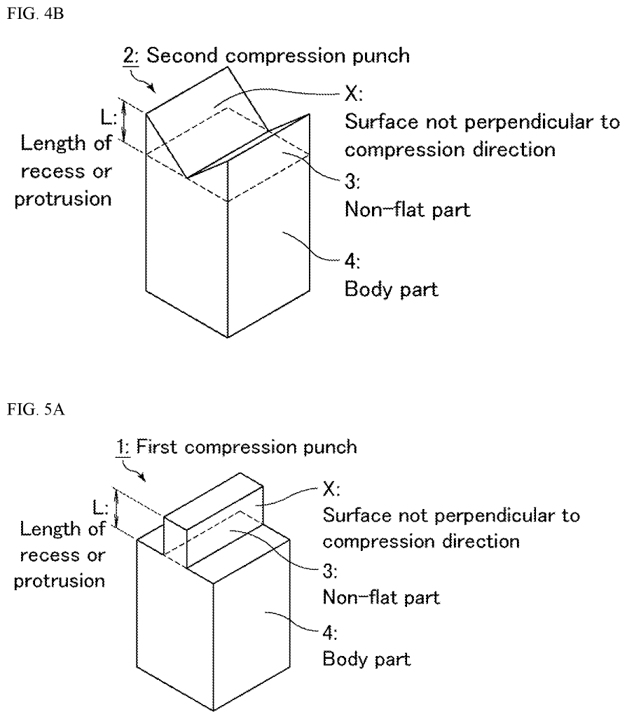

FIGS. 4A, 5A, and 6A each show a perspective view of a first compression punch having a protruding contact surface with a magnetic powder. FIGS. 4B, 5B, and 6B each show a perspective view of a second compression punch having a recessed contact surface with a magnetic powder. Each compression punch includes a body part 4 and a contact surface X with a magnetic powder 10 that is not perpendicular to the compression direction. Each compression punch includes a non-flat part 3 and the body part 4. Here, the non-flat part 3 refers to a part which includes the surface X and in which the compression punch intersects planes perpendicular to the compression direction and passing through the surface X. The body part 4 refers to a part of the compression punch which is different from the non-flat part 3. For example, in FIG. 5A, the protrusion indicated by the reference numeral 3 corresponds to the non-flat part, and the quadrangular prism indicated by the reference numeral 4 located below the protrusion corresponds to the body part. In FIGS. 4A to 6B, the boundaries between the non-flat part 3 and the body part 4 are indicated by a dashed line. The cross-section perpendicular to the compression direction of the body part 4 may have a polygonal shape, including a triangle or a quadrangle, a circular shape, a U-shape, a V-shape, an arc shape, an elliptical shape, an annular shape, or other shape. The shape may be selected according to the desired compression molded product.

The length L of the non-flat part 3 of the compression punch is preferably at least 5% but not more than 80%, more preferably at least 10% but not more than 60%, of the height of a magnetic powder compression molded product 11 to be obtained. Here, the length L of the non-flat part 3 refers to the length of the non-flat part 3 at the point where the length of the non-flat part 3 is maximum in the compression direction. Moreover, the height of the magnetic powder compression molded product 11 refers to the length in the compression direction of the magnetic powder compression molded product 11 obtained in the compression molding step. When the length L of the non-flat part 3 is at least 5% of the height of the magnetic powder compression molded product 11, the fluidity of the magnetic powder in the compressing step tends to improve, resulting in a further improved magnetic orientation ratio. When the length L of the protrusion is at most 80% of the height of the magnetic powder compression molded product 11, the green compact is less likely to disintegrate during the insertion or removal of the compression punch, and a decrease in magnetic orientation ratio tends to be reduced.

In the first compression punch shown in FIG. 4A, two planes enclosing the apex angle θ of the non-flat part 3 correspond to the surface X not perpendicular to the compression direction. In the first compression punch shown in FIG. 4A, the apex angle θ is preferably at least 10° but not more than 120°, more preferably at least 30° but not more than 90°. When the apex angle is at least 10°, a decrease in orientation during the insertion or removal of the compression punch after orientation can be easily reduced. When the apex angle is not more than 120°, the fluidity of the magnetic powder during compression is improved, which facilitates orientation of the magnetic powder near the center and facilitates improvement of the magnetic orientation ratio of the magnetic powder.

In the first compression punch shown in FIG. 5A, the side surfaces of the central protrusion as the non-flat part 3 correspond to the surface X not perpendicular to the compression direction. In the first compression punch shown in FIG. 5A, the area of the cross-section perpendicular to the compression direction of the protrusion is preferably at least 10% but not more than 75%, more preferably at least 30% but not more than 50%, of the area of the cross-section perpendicular to the compression direction of the body part 4 of the first compression punch (the area of the cross-section perpendicular to the compression direction of the cavity of the mold). The length L of the protrusion is preferably at least 5% but not more than 80%, more preferably at least 10% but not more than 60%, of the diameter or shortest side of the cross-section perpendicular to the compression direction of the body part 4. Moreover, the diameter or shortest side of the cross-section perpendicular to the compression direction of the body part 4 refers to the diameter when the body part 4 is a cylinder, and the length of the shorter side of the quadrangle when the body part 4 is a quadrangular prism.

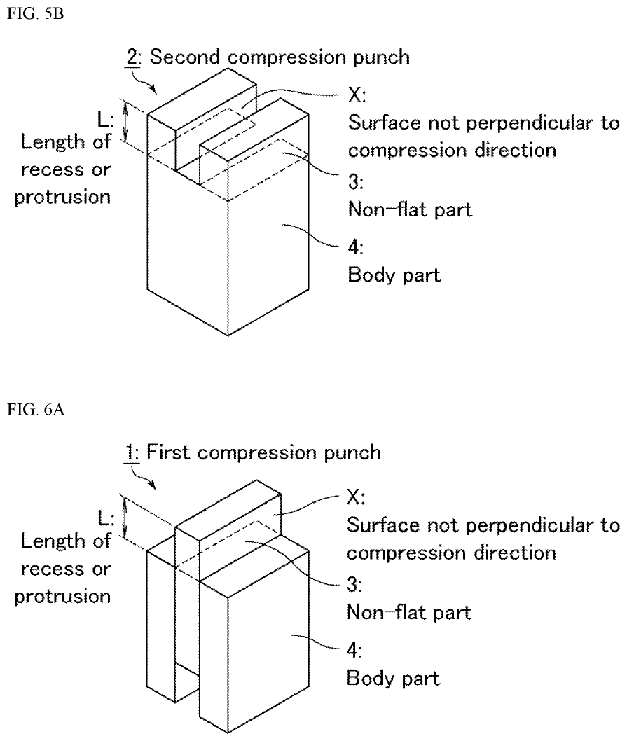

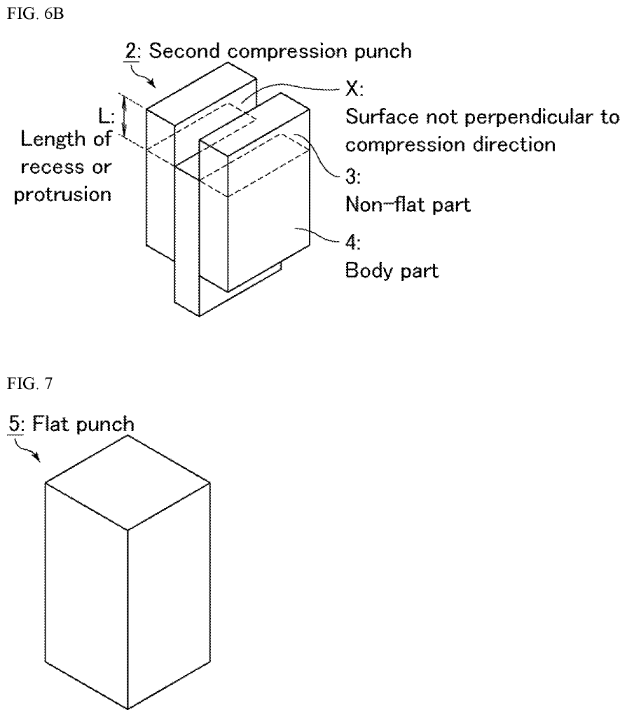

The compression punch shown in FIGS. 6A and 6B is made movable by separating into a central portion forming a non-flat part 3 and two side portions each partially forming a body part 4. When the central portion forming a non-flat part 3 is movable and protrudes from the contact surface with the magnetic powder 10 of each side portion partially forming a body part 4, the compression punch corresponds to a first compression punch having a protruding contact surface as shown in FIG. 6A. When the contact surface with the magnetic powder of the central portion forming a non-flat part 3 is retracted relative to the contact surface with the magnetic powder 10 of each side portion partially forming a body part 4, the compression punch corresponds to a second compression punch having a recessed contact surface with the magnetic powder as shown in FIG. 6B. When there is no difference in level between the contact surfaces with the magnetic powder 10 of each side portion partially forming a body part 4 and the central portion forming a non-flat part 3, the compression punch corresponds to a flat punch.

When the compression punch having a contact surface not perpendicular to the compression direction is used, the compression punch having a contact surface not perpendicular to the compression direction may always be used throughout the compression in the compressing step, or may be used during part of the compression. In these cases, for example, the above-described movable compression punch may be used, or a set of flat punches may be used in combination in the compressing step.

In a specific example of a compression method, the compression punch used includes a first compression punch having a protruding contact surface with the magnetic powder and a second compression punch having a recessed contact surface with the magnetic powder, and the magnetic powder is sandwiched and compressed between the first compression punch and the second compression punch. In order to further improve the fluidity of the magnetic powder during the compression, preferably, the first compression punch and the second compression punch are swapped and the magnetic powder is compressed therebetween two or more times. The number of compressions is more preferably three or more. The upper limit of the number of compressions is not limited, but is preferably 20 or less. Here, when a plurality of compressions are performed, the first compression punch and the second compression punch may be alternately swapped for each of all the compressions, or the first compression punch and the second compression punch may be swapped for only one compression.

FIG. 1 shows a process flowchart of a method using a first compression punch and a second compression punch. The topmost step corresponds to a compressing step and shows an embodiment in which the magnetic powder is compressed between the first compression punch and the second compression punch, followed by repeating swapping of the first compression punch and the second compression punch and compression therebetween four times.

When the first compression punch and the second compression punch are used, the contact surface of the first compression punch and the contact surface of the second compression punch preferably have shapes that fit each other in order for the compression to impart greater deformation to the green compact of the magnetic powder and allow a larger amount of the magnetic powder to flow. For example, in the combination of the compression punches shown in FIGS. 4A and 4B, the combination of the compression punches shown in FIGS. 5A and 5B, and the combination of the compression punches shown in FIGS. 6A and 6B, the contact surfaces have shapes that fit each other.

In another specific example of a compression method, the compression punch used includes a first compression punch having a protruding contact surface with the magnetic powder and a flat punch having a flat contact surface with the magnetic powder, and the magnetic powder is sandwiched and compressed between the first compression punch and the flat punch, and then the magnetic powder is sandwiched and compressed between the flat punch and a second compression punch having a recessed contact surface with the magnetic powder used instead of the first compression punch. Another exemplary method may also be used in which the compression punch used includes a second compression punch having a recessed contact surface with the magnetic powder and a flat punch having a flat contact surface with the magnetic powder, and the magnetic powder is sandwiched and compressed between the second compression punch and the flat punch, and then the magnetic powder is sandwiched and compressed between the flat punch and a first compression punch having a protruding contact surface with the magnetic powder used instead of the second compression punch. Compression after swapping of the first compression punch and the second compression punch may be performed two or more times. The number of compressions is preferably three or more. The upper limit of the number of compressions is not limited, but is preferably 20 or less.

FIG. 2 shows a process flowchart of a method using a second compression punch and a flat punch. The topmost step corresponds to a compressing step and shows an embodiment in which the magnetic powder is compressed between a first compression punch and the flat punch, followed by compression using the second compression punch instead of the first compression punch, followed by compression using the first compression punch instead of the second compression punch, followed by compression using the second compression punch instead of the first compression punch.

In the compressing step, the magnitude of the pressure applied to the mold is not limited, but is preferably at least 0.1 t/cm² but not more than 4 t/cm², more preferably at least 0.5 t/cm² but not more than 2 t/cm². With a pressure of less than 0.1 t/cm², the magnetic powder tends to fail to undergo reorientation, resulting in a decrease in magnetic powder filling factor. With a pressure of more than 4 t/cm², impregnation with a thermosetting resin, if used, may be insufficient, resulting in molding failure.

In the compressing step, two or more compressions are preferably performed in which the pressure during the immediately succeeding compression is higher than the pressure during the immediately preceding compression in two consecutive compressions. For any compression other than the two consecutive compressions, the pressure during the immediately succeeding compression may be higher or lower than or equal to the pressure during the immediately preceding compression. The pressure during the immediately succeeding compression may be higher than the pressure during the immediately preceding compression in all compressions. In the two consecutive compressions, the pressure during the immediately succeeding compression is preferably at least 0.1 t/cm², more preferably at least 1 t/cm² higher than the pressure during the immediately preceding compression. Such a technique of compression greatly improves not only the magnetic powder filling factor but also the magnetic orientation ratio.

The compression direction of the compression punch is preferably perpendicular to the magnetic field orientation direction. Herein, the term “perpendicular to the magnetic field orientation direction” means substantially perpendicular (90°±5°), preferably perfectly perpendicular.

The contact surface X with the magnetic powder that is not perpendicular to the compression direction of the compression punch is preferably parallel to the magnetic field orientation direction. Here, the term “parallel” means substantially parallel (0°±5°), preferably perfectly parallel. When the compression in the compressing step is carried out using the compression punch placed so that the surface X is parallel to the magnetic field orientation direction, the amount of the magnetic powder pressed against the compression punch during orientation is reduced, and the green compact is less likely to disintegrate during the insertion or removal of the compression punch, so that a decrease in magnetic orientation ratio can be reduced.

### Compression Molding Step

In the compression molding step, the compressed magnetic powder may be compression molded using a molding punch having a different shape from the compression punch. The molding punch having a different shape from the compression punch is capable of preparing a compression molded product to have the shape of the final anisotropic magnetic powder compression molded product. For example, a quadrangular prism or cylindrical compression molded product may be prepared using the above-described flat punch whose entire contact surface with the magnetic powder is flat, etc. In FIGS. 1 and 2, the second step corresponds to a compression molding step.

In the compression molding step, an external magnetic field can also be applied for magnetic field orientation. The magnitude of the external magnetic field is not limited, but is preferably 0.5 T or more, more preferably 1 T or more. An external magnetic field of less than 0.5 T may fail to sufficiently orient the magnetic powder.

In the compression molding step, the magnitude of the pressure applied to the mold is not limited, but is preferably at least 0.1 t/cm² but less than 12 t/cm², more preferably at least 0.5 t/cm² but less than 10 t/cm². With a pressure of less than 0.1 t/cm², the magnetic powder tends to fail to undergo reorientation, resulting in a decrease in magnetic powder filling factor. With a pressure of not less than 12 t/cm², impregnation with a thermosetting resin, if used, tends to be insufficient, resulting in molding failure.

Any magnetic powder may be used in the method of preparing an anisotropic magnetic powder compression molded product according to embodiments of the present disclosure. Examples include SmFeN-based, NdFeB-based, and SmCo-based rare earth magnetic powders. Among these, SmFeN-based magnetic powders are preferred because of their heat resistance and absence of rare metals. Examples of the SmFeN-based magnetic powders include nitrides having a Th₂Zn₁₇-type crystal structure and containing the rare earth metal Sm, iron (Fe), and nitrogen (N) as represented by the formula: SmₓFe_{100-x-y}N_{y}, preferably wherein the value of “x” is at least 8.1 atom % but not more than 10 atom %; the value of “y” is at least 13.5 atom % but not more than 13.9 atom %; and the balance is mainly Fe.

SmFeN-based magnetic powders may be produced by the method disclosed in JP H11-189811 A. NdFeB-based magnetic powders may be produced by the HDDR method disclosed in WO 2003/85147. SmCo-based magnetic powders may be produced by the method disclosed in JP H08-260083 A.

The average particle size of the magnetic powder used is preferably 10 μm or less. In view of magnetic properties, it is more preferably 6 μm or less, still more preferably 4 μm or less. With an average particle size of more than 10 μm, the magnetic powder tends to have a significantly reduced coercive force due to the increased grain size. Herein, the average particle size is defined as the particle size corresponding to 50% of the cumulative undersize distribution by volume. For example, it can be measured with a laser diffraction particle size distribution analyzer (HELOS & RODOS available from Japan Laser Corporation).

D90/D10 in the particle size distribution of the magnetic powder is preferably not more than 4, more preferably not more than 3, wherein D10 and D90 represent the particle sizes corresponding to 10% and 90%, respectively, of the cumulative particle size distribution by volume of the magnetic powder. When the D90/D10 value is more than 4, the magnetic properties, such as intrinsic coercive force and squareness, of the magnetic powder can be deteriorated due to the increase of magnetic particles with relatively large particle sizes and small intrinsic coercive forces.

The magnetic powder may be subjected to phosphate treatment. The phosphate treatment results in the formation of a passive film having a P—O bond on the surface of the magnetic powder.

The phosphate treatment may be carried out by reacting the magnetic powder with a phosphate treatment agent. Examples of the phosphate treatment agent include orthophosphoric acid, sodium dihydrogen phosphate, potassium dihydrogen phosphate, ammonium dihydrogen phosphate, diammonium hydrogen phosphate, zinc phosphate, calcium phosphate, and other phosphates, hypophosphorous acid and hypophosphites, pyrophosphoric acid, polyphosphoric acid, and other inorganic phosphoric acids, and organic phosphoric acids, and salts thereof.

From the standpoint of protection against oxidation during the preparation of a molded product and during the use of the molded product, the magnetic powder is preferably subjected to a silica treatment in which it is treated with an alkyl silicate. The alkyl silicate may be represented by the following formula. In particular, the alkyl silicate is preferably methyl silicate or ethyl silicate.

SinO₍ₙ₋₁₎(OR)₍₂ₙ₊₂₎

In the formula, R represents an alkyl group, and n represents an integer of 1 to 10.

In the silica treatment, the above-described alkyl silicate and water required to hydrolyze the silicate may be mixed with the magnetic powder, followed by heat treatment in an inert gas atmosphere to form a silica thin film. Examples of the water required to hydrolyze the silicate include acidic aqueous solutions such as acetic acid, sulfuric acid, and phosphoric acid aqueous solutions, and basic aqueous solutions such as ammonia water, and sodium hydroxide and potassium hydroxide aqueous solutions. The amount of the alkyl silicate mixed is preferably at least 1 but not more than 4 parts by weight, more preferably at least 1.5 but not more than 2.5 parts by weight, per 100 parts by weight of the magnetic powder.

The magnetic powder is preferably treated with a coupling agent in order to enhance the magnetic properties of the magnetic powder and to improve wettability between the magnetic powder and the resin and magnet strength. In particular, the magnetic powder subjected to the above-described silica treatment is preferably treated with a coupling agent.

Examples of the coupling agent include, but are not limited to, silane coupling agents containing no alkyl or alkenyl group having at least 8 but not more than 24 carbons, and coupling agents containing an alkyl or alkenyl group having at least 8 but not more than 24 carbons. The number of carbons of the alkyl or alkenyl group is preferably at least 10 but not more than 24. Here, when the number of carbons of the alkyl or alkenyl group is less than 8, the coupling agent may provide insufficient lubricity, while when the number of carbons is more than 24, the treatment liquid may be significantly viscous, making it difficult to form a uniform coating.

Examples of the coupling agents containing an alkyl or alkenyl group having at least 8 but not more than 24 carbons include silane coupling agents, phosphate coupling agents, and hydrogen phosphite coupling agents. These coupling agents may be used alone or in combinations of two or more. Here, the term “coupling agent” refers to a compound having two or more different groups in the molecule, in which one of the groups is a group that acts on an inorganic material and the other is a group that acts on an organic material.

Examples of the silane coupling agents containing an alkyl or alkenyl group having at least 8 but not more than 24 carbons include compounds represented by the following formula. Specific examples include decyltrimethoxysilane, decyltriethoxysilane, dodecyltrimethoxysilane, dodecyltriethoxysilane, hexadecyltrimethoxysilane, hexadecyltriethoxysilane, octadecyltrimethoxysilane, octadecyltriethoxysilane, and octyltriethoxysilane. Among these, octadecyltriethoxysilane or octyltriethoxysilane is preferred.

(R¹)ₓSi(OR²)₍₄₋ₓ₎

In the formula, R¹ represents an alkyl group represented by CₙH₂ₙ₊₁ or an alkenyl group represented by CₙH₂ₙ₊₁, where n represents an integer of 8 to 24; R² represents an alkyl group represented by CₘH₂ₘ₊₁, where m represents an integer of 1 to 4; and x represents an integer of 1 to 3.

In the silane coupling agents, the group that acts on an organic material is, for example, a group in which a silicon atom is directly bonded to a carbon atom, and corresponds to R¹ in the formula, where the group that acts on an inorganic material is OR².

Examples of the phosphate coupling agents containing an alkyl or alkenyl group having at least 8 but not more than 24 carbons include compounds represented by the following formula. Specific examples include didecyl acid phosphate, isodecyl acid phosphate, isotridecyl acid phosphate, lauryl acid phosphate, oleyl acid phosphate, stearyl acid phosphate, isostearyl acid phosphate, and tetracosyl acid phosphate. Among these, oleyl acid phosphate is preferred.

(R¹O)ₓPO(OH)₍₃₋ₓ₎

In the formula, R¹ represents an alkyl group represented by CₙH₂ₙ₊₁ or an alkenyl group represented by CₙH₂ₙ₋₁, where n represents an integer of 8 to 24, and x represents an integer of 1 to 2.

In the phosphate coupling agents, the group that acts on an organic material corresponds to R¹O in the formula, where the group that acts on an inorganic material is OH.

Examples of the hydrogen phosphite coupling agents containing an alkyl or alkenyl group having at least 8 but not more than 24 carbons include compounds represented by the following formula. Specific examples include didecyl hydrogen phosphite, dilauryl hydrogen phosphite, and dioleyl hydrogen phosphite. Among these, dioleyl hydrogen phosphite is preferred.

(R¹O)₂POH

In the formula, R¹ represents an alkyl group represented by CₙH₂ₙ₊₁ or an alkenyl group represented by CₙH₂ₙ₋₁, where n represents an integer of 8 to 24.

In the hydrogen phosphite coupling agents, the group that acts on an organic material corresponds to R¹O in the formula, where the group that acts on an inorganic material is OH.

The silane coupling agents, phosphate coupling agents, or hydrogen phosphite coupling agents containing an alkyl or alkenyl group having at least 8 but not more than 24 carbons may be used alone or in combinations of two or more.

In the treatment with a coupling agent containing an alkyl or alkenyl group having at least 8 but not more than 24 carbons, the above-described coupling agent and water required to hydrolyze the coupling agent may be mixed with the magnetic powder, followed by heat treatment in an inert gas atmosphere to form a coupling agent coating. Examples of the water required to hydrolyze the coupling agent include acidic aqueous solutions such as acetic acid, sulfuric acid, and phosphoric acid aqueous solutions, and basic aqueous solutions such as ammonia water, and sodium hydroxide and potassium hydroxide aqueous solutions. The amount of the coupling agent mixed is preferably at least 0.01 but not more than 1 part by weight, more preferably at least 0.05 but not more than 0.5 parts by weight, per 100 parts by weight of the magnetic powder. With an amount of less than 0.01 parts by weight, sufficient lubricity may not be provided to the magnetic powder, while with an amount of more than 1 part by weight, the mechanical strength of the molded product may be impaired.

The treatment with a coupling agent may be carried out using a silane coupling agent different from the above-described silane coupling agents containing an alkyl or alkenyl group having at least 8 but not more than 24 carbons (i.e., a silane coupling agent containing no alkyl or alkenyl group having at least 8 but not more than 24 carbons). Examples of such silane coupling agents different from the silane coupling agents containing an alkyl or alkenyl group having at least 8 but not more than 24 carbons include γ-(2-aminoethyl)aminopropyltrimethoxysilane, γ-(2-aminoethyl)aminopropylmethyldimethoxysilane, γ-methacryloxypropyltrimethoxysilane, γ-methacryloxypropylmethyldimethoxysilane, N-β-(N-vinylbenzylaminoethyl)-γ-aminopropyltrimethoxysilane hydrochloride, γ-glycidoxypropyltrimethoxy silane, γ-mercaptopropyltrimethoxysilane, methyltrimethoxysilane, methyltriethoxysilane, vinyltriacetoxysilane, γ-chloropropyltrimethoxy silane, hexamethylenedisilazane, γ-anilinopropyltrimethoxysilane, vinyltrimethoxysilane, dimethyloctadecyl[3-(trimethoxysilyl)propyl]ammonium chloride, γ-chloropropylmethyldimethoxysilane, γ-mercaptopropylmethyldimethoxysilane, methyltrichlorosilane, dimethyldichlorosilane, trimethylchlorosilane, vinyltrichlorosilane, vinyltris(β-methoxyethoxy)silane, vinyltriethoxysilane, β-(3,4-epoxycyclohexyl)ethyltrimethoxysilane, γ-glycidoxypropylmethyldiethoxysilane, N-β-(aminoethyl)-γ-aminopropyltrimethoxysilane, N-β-(aminoethyl)-γ-aminopropylmethyldimethoxysilane, γ-aminopropyltriethoxysilane, ureidopropyltriethoxysilane, γ-isocyanatopropyltriethoxysilane, bis(3-triethoxysilylpropyl)tetrasulfane, γ-isocyanatopropyltrimethoxysilane, vinylmethyldimethoxysilane, 1,3,5-N-tris(3-trimethoxysilylpropyl) isocyanurate, and N-(1,3-dimethylbutylidene)-3-(triethoxysilyl)-1-propanamine. Moreover, examples of such silane coupling agents having a cyclic structure include coupling agents having an alicyclic structure such as a monocyclic or bicyclic ring or an aromatic ring as the cyclic structure. Examples of the coupling agents having an aromatic ring backbone include N-phenyl-3-aminopropyltrimethoxysilane, N-aminoethylaminomethylphenyl-3-ethyltrimethoxysilane, p-styryltrimethoxysilane, and m-allylphenylpropyltriethoxysilane. These silane coupling agents may be used alone or in combinations of two or more.

In the treatment with a silane coupling agent containing no alkyl or alkenyl group having at least 8 but not more than 24 carbons, the above-described coupling agent and water required to hydrolyze the coupling agent may be mixed with the magnetic powder, followed by heat treatment in an inert gas atmosphere to form a silane coupling agent coating. Examples of the water required to hydrolyze the coupling agent include acidic aqueous solutions such as acetic acid, sulfuric acid, and phosphoric acid aqueous solutions, and basic aqueous solutions such as ammonia water, and sodium hydroxide and potassium hydroxide aqueous solutions. The amount of the silane coupling agent mixed is preferably at least 0.1 but not more than 2 parts by 5 weight, more preferably at least 0.2 but not more than 1.2 parts by weight, per 100 parts by weight of the magnetic powder. With an amount of less than 0.1 parts by weight, the coupling agent tends to produce only a small effect, while with an amount of more than 2 parts by weight, the magnetic powder tends to aggregate, resulting in a decrease in magnetic properties.

In order to enhance lubricity of the magnetic powder to reduce friction between the particles during the compression molding and thereby produce a molded product highly filled with the magnetic powder, the treatment with a coupling agent is preferably carried out by treatment with a silane coupling agent containing no alkyl or alkenyl group having at least 8 but not more than 24 carbons and then with a coupling agent containing an alkyl or alkenyl group having at least 8 but not more than 24 carbons.

A sintered magnet can be produced by sintering the anisotropic magnetic powder compression molded product prepared by the method of preparing an anisotropic magnetic powder compression molded product according to embodiments of the present disclosure. A bonded magnet can also be produced by mixing the prepared anisotropic magnetic powder compression molded product with a resin. When a thermosetting resin is used to prepare a bonded magnet, the thermosetting resin may be contacted with the prepared anisotropic magnetic powder compression molded product, followed by curing by heat treatment to produce a bonded magnet. Moreover, when a thermoplastic resin is used to prepare a bonded magnet, the heated thermoplastic resin may be contacted with the prepared anisotropic magnetic powder compression molded product, followed by cooling to produce a bonded magnet. The following describes embodiments in which a thermosetting resin is used.

### Thermosetting Resin Contacting Step

In the contacting step, the anisotropic magnetic powder compression molded product and a thermosetting resin may be contacted and then compressed. The magnetic powder which has a very small average particle size of 10 μm or less and is bulky will be filled at a low filling factor. When the magnetic powder sufficiently oriented in the compressing step and the compression molding step is contacted and compressed with the thermosetting resin, the extra thermosetting resin can be removed to further increase the magnetic powder filling factor and the magnetic orientation ratio, thereby improving the magnetic properties of the bonded magnet.

The contact between the anisotropic magnetic powder compression molded product and the thermosetting resin may be carried out by any method, such as by adding the thermosetting resin to the anisotropic magnetic powder compression molded product in the mold to contact them. The volume of the thermosetting resin to be contacted is not limited, but is preferably at least 0.25 but not more than 2 times, more preferably at least 0.5 but not more than 1.5 times the volume of the molded product. With a factor of less than 0.25 times, impregnation of the anisotropic magnetic powder compression molded product with the thermosetting resin tends to be insufficient, resulting in molding failure. With a factor of more than 2 times, the resin and magnetic powder tend to overflow from the mold, resulting in a reduced yield as well as the need to remove the overflow materials.

The viscosity of the thermosetting resin is not limited, but is preferably 200 mPa·s or less, more preferably 100 mPa·s or less, still more preferably 50 mPa·s or less, most preferably 20 mPa·s or less. With a viscosity of more than 200 mPa·s, insufficient impregnation tends to occur, resulting in molding failure.

The thermosetting resin may be any resin capable of thermosetting. Examples of the pre-cured thermosetting resin in contact with the anisotropic magnetic powder compression molded product include thermosetting monomers and thermosetting prepolymers. Examples of the thermosetting monomers include norbornene-based monomers, epoxy monomers, phenolic monomers, acrylic monomers, and vinyl ester monomers. Examples of the epoxy monomers include alicyclic epoxy monomers, bisphenol A-type epoxy monomers, and bisphenol F-type epoxy monomers. Examples of the thermosetting resin include epoxy resins, phenol resins, melamine resins, guanamine resins, unsaturated polyesters, vinyl ester resins, diallyl phthalate resins, silicone resins, alkyd resins, furan resins, acrylic resins, urea resins, allyl carbonate resins, polyurethane resins, polyimide resins, and polyester resins.

The thermosetting resin may be incorporated together with an initiator or curing agent for the thermosetting resin. Examples of the initiator include thermal cationic polymerization initiators such as benzenesulfonic acid esters and alkylsulfonium salts, and thermal radical polymerization initiators such as azo compounds and peroxides. Examples of the curing agent include amine curing agents, acid anhydride curing agents, polyamide curing agents, imidazole curing agents, phenol resin curing agents, polymercaptan resin curing agents, polysulfide resin curing agents, organic acid hydrazide curing agents, and isocyanate curing agents. Examples of the amine curing agents include diaminodiphenylsulfone, metaphenylenediamine, diaminodiphenylmethane, diethylenetriamine, and triethylenetetramine.

The magnitude of the pressure applied in the post-contact compressing step is not limited, but is preferably at least 4 t/cm² but not more than 11 t/cm², more preferably at least 6 t/cm² but not more than 10 t/cm², in order to produce a more highly filled magnet. At a pressure of less than 4 t/cm², the magnetic powder filling factor tends to be insufficiently increased. At a pressure of more than 11 t/cm², the coercive force tends to be reduced.

The post-contact compressing step may also include magnetic field orientation as in the compressing step described earlier. The magnitude of the external magnetic field applied for magnetic field orientation is not limited, and the magnitude of the external magnetic field in the compressing step described earlier can be used directly.

Heat treatment step

After the contact with the thermosetting resin, the thermosetting resin may be cured by heat treatment. The temperature of heat treatment is not limited, but is preferably at least 100° C. but not higher than 220° C., more preferably at least 110° C. but not higher than 200° C. At a temperature of lower than 100° C., insufficient curing of the resin tends to proceed, resulting in poor strength. At a temperature of higher than 10 220° C., oxidation of the resin or magnetic powder by the air tends to proceed, resulting in poor strength or poor magnetic properties.

The duration of heat treatment is not limited, but is preferably at least 1 minute but not more than 120 minutes, more preferably at least 1 minute but not more than 30 minutes. With a duration of less than 1 minute, insufficient curing of the resin tends to proceed, resulting in poor strength. With a duration of more than 120 minutes, oxidation of the resin by the air tends to proceed, resulting in poor strength.

After completion of the heat treatment, the inner plate and punches may be drawn out of the mold to remove the molded bonded magnet, which may then be magnetized by applying a pulse magnetic field in the orientation direction.

The magnetizing field is preferably at least 1 T but not higher than 36 T, more preferably at least 3 T but not higher than 12 T. At a field of lower than 1 T, the magnet may be insufficiently magnetized and thus fail to exhibit remanence. At a field of higher than 36 T, the heat generated during the magnetization may cause excessive heat shock, resulting in breakage of the magnet.

A bonded magnet according to embodiments of the present disclosure contains a magnetic powder and a cured thermosetting resin and has a magnetic powder filling factor of 70 vol % or more and a magnetic orientation ratio of 96% or more. The bonded magnet can be prepared, for example, by subjecting the compression molded product obtained by the above-described method of preparing an anisotropic magnetic powder compression molded product according to the present embodiments to the above-described thermosetting resin contacting step and heat treatment step. Here, the magnetic powder, the thermosetting resin, the average particle size of the magnetic powder, etc. are as described above.

The percentage of lack of impregnation of the bonded magnet, which refers to the ratio of the area not actually occupied by the resin to the area that should be occupied by the resin, is preferably not more than 12%, more preferably not more than 10%, still more preferably not more than 5%, most preferably not more than 1%. A percentage of lack of impregnation of more than 12% tends to result in a decrease in mechanical strength. The percentage of lack of impregnation can be determined by performing binary analysis (BMPEdit) of the brightness of an image observed with an optical microscope at the lowest magnification covering the entire cross-section of the bonded magnet to determine the area of the portion not impregnated with the resin (the area of the resin-lacking portion) and the area of the entire cross-section, i.e., the outline of the image (the area of the cross-section), and calculating the ratio of the area of the resin-lacking portion to the area of the cross-section. Here, the cross-section of the bonded magnet is created by cutting the prepared bonded magnet so that the cross-section passes through the center of the surface contacted with the resin and is perpendicular to the contact surface, and the cross-section also has the largest area.

The proportion of the magnetic powder in the bonded magnet, i.e., filling factor, is not limited, but is preferably 70 vol % or more, more preferably 71 vol % or more. A proportion of 70 vol % or more can lead to a higher remanence.

The magnetic orientation ratio of the bonded magnet is preferably 96% or more, more preferably 97% or more, still more preferably 98% or more. A magnetic orientation ratio of 96% or more can lead to a higher remanence. Here, the magnetic orientation ratio can be determined by dividing the remanence of the bonded magnet by the product of the remanence of the magnetic powder and the volume filling factor of the bonded magnet and multiplying the result by 100.

The intrinsic coercive force of the bonded magnet is not limited, but is preferably 1100 kA/m or more, more preferably 1200 kA/m or more. An intrinsic coercive force of 1100 kA/m or more tends to reduce demagnetization during use in applications such as high-power motors that operate at high temperatures of 120° C. or higher.

The remanence of the bonded magnet is not limited, but is preferably 0.75 T or more, more preferably 0.95 T or more, still more preferably 0.96 T or more. A remanence of 0.75 T or more tends to make it easier to generate torque during use in applications such as motors.

The average particle size and D90/D10 in the particle size distribution of the magnetic powder in the bonded magnet are as described above.

### EXAMPLES

Examples are described below. It should be noted that “%” is by weight unless otherwise specified.

### Production Example 1

### Alkyl Silicate Treatment Step

Into a mixer were introduced 300 g of a SmFeN-based magnetic powder (average particle size: 3 μm, D90/D10 in particle size distribution=2.7) and 7.5 g of ethyl silicate (Si₅O₄(OEt)₁₂), and they were mixed for five minutes in a nitrogen atmosphere. Into the mixture was introduced 0.8 g of ammonia water (pH 11.7), and they were mixed for five minutes, followed by heat treatment at 180° C. under reduced pressure for 10 hours to obtain a SmFeN-based anisotropic magnetic powder having a silica thin film formed on the surface.

### Surface Treatment Step 1

Into a mixer were introduced 300 g of the silica-treated magnetic powder and 1.5 g of an acetic acid aqueous solution (pH 4), and they were mixed for five minutes in a nitrogen atmosphere. To the mixture was added 3 g of 3-glycidoxypropyltriethoxysilane (silane coupling agent KBE-403 available from Shin-Etsu Chemical Co., Ltd.) as a silane coupling agent A, and they were mixed for five minutes in a nitrogen atmosphere. The resulting mixture was taken out and then subjected to heat treatment at 100° C. under reduced pressure for five hours to obtain a magnetic powder having a coating layer formed from the coupling agent A on the silica film.

### Surface Treatment Step 2

Into a mixer were introduced 300 g of the SmFeN-based magnetic powder having a coating layer formed from the coupling agent A and 1.5 g of an acetic acid aqueous solution (pH 4), and they were mixed for five minutes in a nitrogen atmosphere. To the mixture was added a mixed solution containing 0.5 g of octadecyltriethoxysilane (Tokyo Chemical Industry Co., Ltd.) as a coupling agent B and 0.5 g of ethanol, and they were mixed for five minutes in a nitrogen atmosphere. The resulting mixture was subjected to heat treatment at 100° C. under reduced pressure for five hours to obtain a SmFeN-based anisotropic magnetic powder having coating layers formed from the coupling agents A and B on the surface.

### Example 1

### Compressing Step

An amount of 1.5 g of the SmFeN-based anisotropic magnetic powder with coating layers A and B formed on the surface prepared in Production Example 1 was loaded into a non-magnetic carbide mold including a 7×5 mm square cavity. A protruding compression punch as shown in FIG. 4A with a θ of 90°, a length L of the protrusion of 2.5 mm, and a 7×5 mm cross-section of the body part, and a recessed compression punch as shown in FIG. 4B having a recessed shape that fits the shape of the protruding compression punch and having a 7×5 mm cross-section of the body part were attached to the upper and lower parts of the mold, respectively. The magnetic powder was compressed at a compression pressure of 1 t/cm² in an orientation field of 1 T to give a first molded product (green compact).

### Compression Molding Step

Molding punches as shown in FIG. 7 having a flat contact surface with the magnetic powder were attached to the upper and lower parts of the mold, and the green compact obtained in the compressing step was compressed at a compression pressure of 6 t/cm² in an orientation field of 1 T to give an anisotropic magnetic powder compression molded product having a height of 7 mm.

### Thermosetting Resin Contacting/Compressing Step

Then, the upper punch was removed, and 0.34 g of a mixture containing 100 parts by weight of an alicyclic epoxy monomer (tetrahydroindene diepoxide, viscosity at room temperature: 20 mPa·s, density: 1.2 g/cc) and 1.5 parts by weight of a cationic polymerization initiator SI-150L (Sanshin Chemical Industry Co., Ltd.) as a reaction initiator was added dropwise to the obtained anisotropic magnetic powder compression molded product and then allowed to stand for 30 seconds. Furthermore, the compression molded product was compressed at an increased compression pressure of 6 t/cm² in an orientation field of 1 T using flat punches as shown in FIG. 7 as both the upper and lower punches to impregnate the compression molded product with the thermosetting monomer and to discharge the excess mixture component. Thus, a thermosetting resin-impregnated compression molded product was obtained.

### Heat Treatment Step

The obtained resin-impregnated compression molded product was then heated, while being compressed, at 180° C. for three minutes to give a bonded magnet (size: 7×7×5 mm). The volume filling factor, intrinsic coercive force, remanence, percentage of lack of impregnation, and magnetic orientation ratio of the bonded magnet were measured as described below. Table 1 shows the results.

### Volume Filling Factor

The density of the bonded magnet was determined from the dimensions and weight measurements. The determined density was applied to the calibration curve between the magnetic powder filling factor and the magnet density prepared based on the densities of the magnetic powder and the resin, thereby calculating the volume filling factor.

### Percentage of Lack of Impregnation

The prepared bonded magnet was cut so that the cross-section passed through the center of the surface contacted with the thermosetting monomer and was perpendicular to the contact surface, and the cross-section also had the largest area. The cross-section was sanded with sandpaper. As can be seen from the image of the cross-section observed with an optical microscope (magnification: ×25), the resin was present uniformly over the entire cross-section and a lacking portion where impregnation failed was not observed (percentage of lack of impregnation=0).

### Remanence, Intrinsic Coercive Force, and Magnetic Orientation Ratio

The SmFeN-based magnetic powder with coating layers A and B formed on the surface was packed into a sample vessel together with a paraffin wax. After the paraffin wax was melted with a dryer, the easy axes of magnetization were aligned in an orientation field of 2 T. The magnetically oriented sample was pulse magnetized in a magnetizing field of 6 T, and the remanence (T) and intrinsic coercive force (iHc, kA/m) of the sample were measured using a vibrating sample magnetometer (VSM) with a maximum field of 2 T. The SmFeN-based magnetic powder was found to have a remanence of 1.38 T and a coercive force of 1380 kA/m.

Moreover, the bonded magnet prepared in each of the examples was pulse magnetized in a magnetizing field of 6 T and then measured for remanence (T) and intrinsic coercive force (iHc, kA/m) using a BH tracer. The magnetic orientation ratio was calculated by the following equation: Remanence of bonded magnet/(Remanence of magnetic powder×Volume filling factor/100)×100.

### Example 2

An anisotropic magnetic powder compression molded product was prepared as in Example 1, except that a flat punch as shown in FIG. 7 was used as the lower punch in the compressing step. A bonded magnet was prepared as in Example 1 from the obtained anisotropic magnetic powder compression molded product.

### Example 3

In the compressing step, after a first compression was performed as in Example 1, the protruding punch used as the upper punch and the recessed punch used as the lower punch were swapped with each other and a second compression was performed by compression between the punches at a compression pressure of 2 t/cm² in an orientation field of 1 T. Further, the upper and lower punches were swapped again and a third compression was performed by compression between the punches at a compression pressure of 3 t/cm² in an orientation field of 1 T to prepare an anisotropic magnetic powder compression molded product. A bonded magnet was prepared as in Example 1 from the obtained anisotropic magnetic powder compression molded product.

### Comparative Example 1

An anisotropic magnetic powder compression molded product was prepared as in Example 1, except that flat punches as shown in FIG. 6 were used as both the upper and lower punches in the compressing step. A bonded magnet was prepared as in Example 1 from the obtained anisotropic magnetic powder compression molded product.

TABLE 1

| | Conditions of powder compression | | | | | | Evaluation results | | | |
|---|---|---|---|---|---|---|---|---|---|---|
| | | | | | Pressure | | | Intrinsic | Magnetic | Volume |
| | Number of | | | | during | | | coercive | orientation | filling |
| | compressions | | Shape of punch | | compression | Orientation | Remanence | force | ratio | factor |
| Example No. | Times | | Upper | Lower | t/cm² | T | T | kA/m | % | vol % |
| Example 1 | 1 | | Protruding | Recessed | 1 | 1 | 0.958 | 1350 | 97.8 | 71 |
| Example 2 | 1 | | Protruding | Flat | 1 | 1 | 0.950 | 1310 | 97.0 | 71 |
| Example 3 | 3 | First | Protruding | Recessed | 1 | 1 | 0.965 | 1290 | 98.5 | 71 |
| | | Second | Recessed | Protruding | 2 | 1 | | | | |
| | | Third | Protruding | Recessed | 3 | 1 | | | | |

| | | | | | | | | | |
|---|---|---|---|---|---|---|---|---|---|
| Comparative | 1 | Flat | Flat | 1 | 1 | 0.945 | 1260 | 95.1 | 72 |
| Example 1 | | | | | | | | | |

Table 1 shows that, in each of Examples 1 to 3 using a compression punch having a contact surface with the magnetic powder that was not perpendicular to the compression direction, a bonded magnet having a higher magnetic orientation ratio and a higher remanence was obtained than in Comparative Example 1. Further, a much higher magnetic orientation ratio was obtained in Example 3 in which a plurality of compressions were performed using compression punches having shapes different from those used in the just previous compressing step, while the pressure was increased stepwise. Thus, bonded magnets having higher magnetic properties were obtained. This demonstrates that the use of a non-flat compression punch having a surface not perpendicular to the compression direction can increase the fluidity of the magnetic powder during magnetic field orientation and enable the preparation of an anisotropic magnetic powder compression molded product having a high magnetic orientation ratio and a high remanence.

The method of preparing an anisotropic magnetic powder compression molded product according to embodiments of the present disclosure can provide a compression molded product having a high magnetic powder filling factor and a high magnetic orientation ratio. Moreover, this compression molded product can be used to provide a bonded magnet with improved magnetic properties. Such a bonded magnet can be suitably used in applications such as motors.

What is claimed is:

1. A method of preparing an anisotropic magnetic powder compression molded product, the method comprising:
compressing a magnetic powder in a mold using a compression punch while magnetically orienting the magnetic powder to obtain a compressed magnetic powder, wherein the compression punch has a contact surface with the magnetic powder that is not perpendicular to a compression direction; and
compression molding the compressed magnetic powder using a molding punch having a different shape from the compression punch.

2. The method of preparing an anisotropic magnetic powder compression molded product according to claim 1,
wherein in the compressing, the compression punch comprises a first compression punch having a protruding contact surface with the magnetic powder and a second compression punch having a recessed contact surface with the magnetic powder, and the magnetic powder is sandwiched and compressed between the first compression punch and the second compression punch.

3. The method of preparing an anisotropic magnetic powder compression molded product according to claim 2,
wherein in the compressing, after the magnetic powder is compressed between the first compression punch and the second compression punch, the first compression punch and the second compression punch are swapped and the magnetic powder is further compressed therebetween.

4. The method of preparing an anisotropic magnetic powder compression molded product according to claim 2,
wherein in the compressing, the protruding contact surface of the first compression punch and the recessed contact surface of the second compression punch have shapes that fit each other.

5. The method of preparing an anisotropic magnetic powder compression molded product according to claim 1,
wherein in the compressing, the compression punch comprises a first compression punch having a protruding contact surface with the magnetic powder and a flat punch having a flat contact surface with the magnetic powder, and the magnetic powder is sandwiched and compressed between the first compression punch and the flat punch, and then the magnetic powder is sandwiched and compressed between the flat punch and a second compression punch having a recessed contact surface with the magnetic powder.

6. The method of preparing an anisotropic magnetic powder compression molded product according to claim 1,
wherein in the compressing, the compression punch comprises a second compression punch having a recessed contact surface with the magnetic powder and a flat punch having a flat contact surface with the magnetic powder, and the magnetic powder is sandwiched and compressed between the second compression punch and the flat punch, and then the magnetic powder is sandwiched and compressed between the flat punch and a first compression punch having a protruding contact surface with the magnetic powder.

7. The method of preparing an anisotropic magnetic powder compression molded product according to claim 3,
wherein in the compressing, two or more compressions are performed in which a pressure during an immediately succeeding compression is higher than a pressure during an immediately preceding compression in two consecutive compressions.

8. The method of preparing an anisotropic magnetic powder compression molded product according to claim 1,
wherein the compression direction of the compression punch is perpendicular to a magnetic field orientation direction.

9. The method of preparing an anisotropic magnetic powder compression molded product according to claim 1,
wherein the contact surface of the compression punch with the magnetic powder that is not perpendicular to the compression direction is parallel to a magnetic field orientation direction.

10. The method of preparing an anisotropic magnetic powder compression molded product according to claim 1,
wherein the magnetic powder is a SmFeN-based magnetic powder.

11. A method of preparing a bonded magnet, comprising:
preparing an anisotropic magnetic powder compression molded product by the method according to claim 1; and
contacting a thermosetting resin with the anisotropic magnetic powder compression molded product and curing the thermosetting resin by heat treatment.

12. A bonded magnet, comprising:
a magnetic powder; and
a cured thermosetting resin,
the bonded magnet having a magnetic powder filling factor of 70 vol % or more and a magnetic orientation ratio of 96% or more.

13. The bonded magnet according to claim 12,
wherein the magnetic powder is a SmFeN-based magnetic powder.

14. The bonded magnet according to claim 12,
wherein an average particle size of the magnetic powder is at least 1 μm but not more than 10 μm.

15. The bonded magnet according to claim 12,
wherein D90/D10 in a particle size distribution of the magnetic powder is 4 or less.

16. The bonded magnet according to claim 12,
wherein a remanence of the bonded magnet is 0.95 T or more and an intrinsic coercive force of the bonded magnet is 1200 kA/m or more.
